(19) United States
(12) Patent Application Publication
(10) Pub. No.: US 2009/0182469 A1
(43) Pub. Date: Jul. 16, 2009

(54) Adjustable Mirror System

(75) Inventor: Timothy J. Tucker, Oliver Branch, MS (US)

Correspondence Address: FISH & RICHARDSON P.C., P.O. BOX 1022, MINNEAPOLIS, MN, 55440-1022, US

(73) Assignee: LaneScan LLC, Memphis, TN (US)

(21) Appl. No.: 12/351,488

(22) Filed: Jan. 9, 2009

Related U.S. Application Data
(60) Provisional application No. 61/020,640, filed on Jan. 11, 2008.

(30) Foreign Application Priority Data
Jan. 9, 2009 (US) PCT/US2009/030608

(51) Int. Cl. B60R 1/072; G02B 7/182

(52) U.S. Cl. 701/49; 359/872

(57) ABSTRACT

A mirror system facilitates the viewing of an area of a roadway rearwardly and to the side of a vehicle, for example, prior to changing lanes or direction in a roadway. To do so, in response to a user command, the mirror moves from a first position providing the driver with a first view of the roadway adjacent to the vehicle to a second position providing the driver with a second, different view of the roadway adjacent to the vehicle.

### CROSS-REFERENCE TO RELATED APPLICATIONS

This application claims priority to U.S. Provisional Application Ser. No. 61/020,640, filed on Jan. 11, 2008, the entire contents of which are incorporated herein.

### TECHNICAL FIELD

The present disclosure relates to an adjustable mirror system.

### BACKGROUND

Certain vehicles, such as large trucks (for example, tractor trailers) and busses, due to their large size, can present difficulties with respect to driver field of view. In particular, rear view visibility along both the right and left side of the bus or truck body may be limited, especially impacting safety when the driver is changing lanes.

### SUMMARY

Implementations of an automatically adjustable mirror system for a vehicle, for example, a truck or bus, are described below. Generally, the mirror system facilitates the viewing of an area of a roadway rearwardly and to the side of a vehicle, for example, prior to changing lanes or direction in a roadway. To do so, in response to a user command, the mirror moves from a first position providing the driver with a first view of the roadway adjacent to the vehicle to a second position providing the driver with a second, different view of the roadway adjacent to the vehicle.

In various implementations, the mirror system includes at least one mirror mounted to one side of a driver compartment of a vehicle, an activate switch, and a control unit. The mirror is normally oriented in the first position to provide the driver with the first view of a roadway adjacent to the vehicle. The control unit is coupled to the mirror and the activate switch. The control unit is configured to move the mirror from the first position to the second position that provides the driver with a second, different view of the roadway adjacent to the vehicle. The control unit moves the mirror from the first position to the second position without using a feedback device coupled to the mirror to provide position feedback about the mirror.

Some implementations may have one or more of the following features. The mirror can rotate horizontally and vertically, and the control unit can move the mirror both horizontally and vertically to move the mirror from the first position to the second position. The control unit can include a microprocessor, and the microprocessor can be programmed with software to move the mirror from the first position to the second position without using a feedback device coupled to the mirror to provide position feedback about the mirror.

In one aspect, a mirror system can facilitate the viewing of an area of a roadway rearwardly and adjacent to a vehicle. The system includes at least one mirror mounted to one side of a driver compartment of the vehicle, at least one motor coupled to the mirror and configured to move the mirror when activated, an activate switch, and a controller coupled to the motor and the activate switch. The controller is configured to activate the motor to move the mirror to a first position out of a range of possible positions in response to mirror movement input from a driver of the vehicle, and receive an indication from the driver that the first position is a home position. The first position provides the driver with a first view of a roadway adjacent to the vehicle. The controller is also configured to activate the motor to move the mirror to a second position out of a range of possible positions in response to mirror movement input from the driver of the vehicle, and receive an indication from the driver that the second position is a scanning position. The second position provides the driver with a second, different view of the roadway adjacent to the vehicle. The controller stores information regarding the home position of the mirror and the scanning position of the mirror and, in response to the driver activating the activate switch, activates the motor to move the mirror from the home position to the scanning position, based on the stored information, without using a position feedback device coupled to the mirror to provide position feedback about the mirror to the controller.

Implementations of this aspect may include one or more of the following features. The controller may be coupled to the mirror through an existing power mirror system in the vehicle. The at least one motor may include a first motor and a second motor, with the first motor being configured to rotate the mirror horizontally when activated and the second motor being configured to rotate the mirror vertically when activated. The controller may be configured to activate both the first motor and the second motor to move the mirror both horizontally and vertically from the home position to the scanning position.

The stored information regarding the home position of the mirror and the scanning position of the mirror may include an amount of time taken to move the mirror from the home position to the scanning position. To move the mirror from the home position to the scanning position, based on the stored information, without using a position feedback device coupled to the mirror to provide position feedback about the mirror to the controller, the controller may be configured to activate the motor to move the mirror towards the scanning position from the home position for the stored amount of time.

The controller may be configured to apply a pulse width modulated signal to the motor to move the mirror an the stored information regarding the home position of the mirror and the scanning position of the mirror may include a number of pulses of the pulse width modulated signal applied to the motor to move the mirror from the home position to the scanning position. To move the mirror from the home position to the scanning position, based on the stored information, without using a position feedback device coupled to the mirror to provide position feedback about the mirror to the controller, the controller may be configured to apply the stored number of pulses to the motor to move the mirror from the home position to the scanning position.

The stored information regarding the home position of the mirror and the scanning position of the mirror may include an absolute position of the home position within the range of positions and an absolute position of the scanning position within the range of positions. To move the mirror from the home position to the scanning position, based on the stored information, without using a position feedback device coupled to the mirror to provide position feedback about the mirror to the controller, the controller is configured to activate the motor to move the mirror from the absolute position of the home position to the absolute position of the scanning position.

The controller may be configured to sense a voltage across the motor or a current running through the motor and control a speed or torque of the motor while the motor is activated to move the mirror from the home position to the scanning position.

The controller may be configured to activate the motor to move the mirror from the scanning position to the home position, based on the stored information, without using a position feedback device coupled to the mirror to provide position feedback about the mirror to the controller. The controller may be configured to do so in response to the driver releasing the activate switch, or after holding the mirror at the scanning position for a predetermined delay period.

In another aspect, a method of operating a mirror system can facilitate the viewing of an area of a roadway rearwardly and adjacent to a vehicle. The mirror system includes at least one mirror mounted to one side of a driver compartment of the vehicle and at least one motor coupled to the mirror and configured to move the mirror when activated. The method includes activating the motor to move the mirror to a first position out of a range of possible positions in response to mirror movement input from a driver of the vehicle and receiving an indication from the driver that the first position is a home position. The first position provides the driver with a first view of a roadway adjacent to the vehicle. The method also includes activating the motor to move the mirror to a second position out of a range of possible positions in response to mirror movement input from the driver of the vehicle and receiving an indication from the driver that the second position is a scanning position. The second position provides the driver with a second, different view of the roadway adjacent to the vehicle. The method further includes storing information regarding the home position of the mirror and the scanning position of the mirror and, in response to the driver activating an activate switch, activating the motor to move the mirror from the home position to the scanning position, based on the stored information, without using a position feedback device coupled to the mirror to provide position feedback about the mirror.

Implementations of this aspect may include one or more of the following features. The method may include receiving the mirror control input through an existing mirror controller of an existing power mirror system in the vehicle. The at least one motor comprises a first motor and a second motor, with the first motor being configured to rotate the mirror horizontally when activated and the second motor being configured to rotate the mirror vertically when activated. Activating the motor to move the mirror from the home position to the scanning position may include activating both the first motor and the second motor to move the mirror both horizontally and vertically from the home position to the scanning position.

The stored information regarding the home position of the mirror and the scanning position of the mirror may include an amount of time taken to move the mirror from the home position to the scanning position. Activating the motor to move the mirror from the home position to the scanning position may include activating the motor to move the mirror towards the scanning position from the home position for the stored amount of time.

A pulse width modulated signal may be applied to the motor to move the mirror and the stored information regarding the home position of the mirror and the scanning position of the mirror may include a number of pulses of the pulse width modulated signal applied to the motor to move the mirror from the home position to the scanning position. Activating the motor to move the mirror from the home position to the scanning position includes applying the stored number of pulses to the motor to move the mirror from the home position to the scanning position.

The stored information regarding the home position of the mirror and the scanning position of the mirror may include an absolute position of the home position within the range of positions and an absolute position of the scanning position within the range of positions. Activating the motor to move the mirror from the home position to the scanning position includes activating the motor to move the mirror from the absolute position of the home position to the absolute position of the scanning position.

The method may include sensing a voltage across the motor or a current running through the motor and controlling a speed or torque of the motor while the motor is activated to move the mirror from the home position to the scanning position.

The method may include activating the motor to move the mirror from the scanning position to the home position, based on the stored information, without using a position feedback device coupled to the mirror to provide position feedback about the mirror to the control unit. Activating the motor to move the mirror from the scanning position to the home position includes activating the motor in response to the driver releasing the activate switch. The method may include holding the mirror at the scanning position for a predetermined delay period before activating the motor to move the mirror from the scanning position to the home position.

In another aspect, a control unit for use with an existing power mirror system in a vehicle can facilitate the viewing of an area of a roadway rearwardly and adjacent to a vehicle. The control unit includes a housing that stores at least one motor control circuit, a regulated power supply, an activate switch, and a microprocessor. The motor control circuit is configured to be coupled to at least one existing power mirror of the power mirror system, with the existing power mirror mounted to one side of a driver compartment of the vehicle and including at least one motor configured to move the mirror when activated. The regulated power supply is coupled to the motor control circuit and configured to provide power used by the motor control circuit to activate the motor of the existing power mirror. The microprocessor is coupled to the at least one motor control circuit and the activate switch, and is configured to be coupled to at least one existing mirror control switch of the existing power mirror system. The microprocessor is programmed with instructions that, when executed, cause the microprocessor to perform the following operations: (a) cause the motor control circuit to activate the motor to move the mirror to a first position out of a range of possible positions in response to a driver of the vehicle using the mirror control switch to provide mirror movement input, wherein the first position provides the driver with a first view of a roadway adjacent to the vehicle; (b) receive an indication from the driver that the first position is a home position; (c) cause the motor control circuit to activate the motor to move the mirror to a second position out of a range of possible positions in response to a driver of the vehicle using the mirror control switch to provide mirror movement input, wherein the second position provides the driver with a second, different view of the roadway adjacent to the vehicle; (d) receive an indication from the driver that the second position is a scanning position; (e) store information regarding the home position of the mirror and the scanning position of the mirror; and (f) in response to the driver activating the activate switch, cause the motor control circuit to activate the motor to move the mirror from the home position to the scanning position, based on the stored information, without using a position feedback device coupled to the mirror to provide position feedback about the mirror to the microprocessor.

Implementations of this aspect may include one or more of the following features. The at least one motor may include a first motor and a second motor, with the first motor being configured to rotate the mirror horizontally when activated and the second motor being configured to rotate the mirror vertically when activated. The microprocessor may be programmed to cause the motor control circuit to activate both the first motor and the second motor to move the mirror both horizontally and vertically from the home position to the scanning position.

The stored information regarding the home position of the mirror and the scanning position of the mirror may include an amount of time taken to move the mirror from the home position to the scanning position. To move the mirror from the home position to the scanning position, based on the stored information, without using a position feedback device coupled to the mirror to provide position feedback about the mirror to the microprocessor, the microprocessor may be programmed with instructions that cause the microprocessor to cause the motor control circuit to activate the motor to move the mirror towards the scanning position from the home position for the stored amount of time.

The microprocessor may be configured to cause the motor control circuit to apply a pulse width modulated signal to the motor to move the mirror. The stored information regarding the home position of the mirror and the scanning position of the mirror may include a number of pulses of the pulse width modulated signal applied to the motor to move the mirror from the home position to the scanning position. To move the mirror from the home position to the scanning position, based on the stored information, without using a position feedback device coupled to the mirror to provide position feedback about the mirror to the microprocessor, the microprocessor is programmed with instructions that cause the microprocessor to cause the motor control circuit to apply the stored number of pulses to the motor to move the mirror from the home position to the scanning position.

The stored information regarding the home position of the mirror and the scanning position of the mirror may include an absolute position of the home position within the range of positions and an absolute position of the scanning position within the range of positions.

To move the mirror from the home position to the scanning position, based on the stored information, without using a position feedback device coupled to the mirror to provide position feedback about the mirror to the microprocessor, the microprocessor is programmed with instructions that cause the microprocessor to cause the motor control circuit to activate the motor to move the mirror from the absolute position of the home position to the absolute position of the scanning position.

The microprocessor may be programmed with instructions that cause the microprocessor to sense a voltage across the motor or a current running through the motor and control a speed or torque of the motor while the motor is activated to move the mirror from the home position to the scanning position.

The microprocessor may be programmed with instructions that cause the microprocessor to cause the motor control circuit to activate the motor to move the mirror from the scanning position to the home position, based on the stored information, without using a position feedback device coupled to the mirror to provide position feedback about the mirror to the microprocessor. The microprocessor may be programmed to do so in response to the driver releasing the activate switch, or after holding the mirror at the scanning position for a predetermined delay period.

One or more of the described implementations may have one or more advantages. For instance, implementations which do not rely on, for example, modifying the mirror by installing a feedback device within the mirror, allow the system to be easily and cheaply installed in vehicles that have existing power mirrors, and therefore the vehicle need not be retrofitted with specialized mirrors. Also, implementations that provide vertical control of the mirror allow drivers to scan a field of view that is outward and downward of the normal viewing position for the mirror when, e.g., the driver wants to change lanes. This can be particularly important to drivers of certain vehicles, such as tractor-trailers, when changing lanes to the right.

Implementations of the described techniques may include hardware, software, a method or process, a system, or an apparatus.

The details of one or more implementations are set forth in the accompanying drawings and the description below. Other features will be apparent from the description and drawings.

### DESCRIPTION OF DRAWINGS

FIG. 1 is a schematic diagram of a truck having an automatically adjustable mirror system;

FIG. 2 is a schematic plan view illustrating a field of view of left and right hand sideview mirrors for a home setpoint position;

FIG. 3 is a schematic plan view illustrating a field of view of left and right hand sideview mirrors for a scanning setpoint position;

FIG. 4 is a schematic showing an example of a control unit that controls the mirrors in the automatically adjustable mirror system;

FIGS. 5A and 5B are flow charts showing an example of a process to detect and react to the actuation of switches of the control unit;

FIGS. 6-8 are flow charts showing various processes for implementing a set position process and an activate scan process;

FIGS. 9A and 9B show an example of a calibration process to determine the total movement range of a mirror in the horizontal and vertical directions.

### DETAILED DESCRIPTION

In general, an automatically adjustable mirror system can be provided on a vehicle, for example, a truck or bus, to facilitate the viewing of an area of a roadway rearwardly and to the side of a body of a truck or bus, for example, prior to changing lanes or direction in the roadway. The following provides a detailed description of one or more implementations of such an adjustable mirror system. The adjustable mirror system is described with respect to a tractor-trailer vehicle, but is generally applicable to any vehicle.

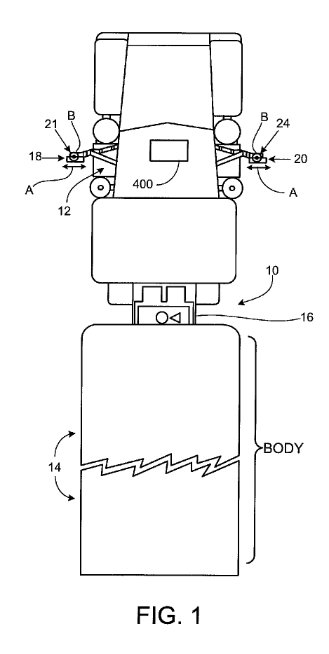

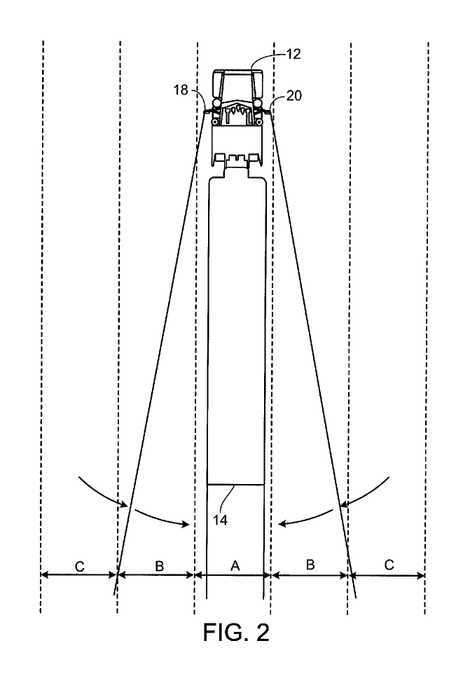

Referring to FIG. 1, a truck 10 having a driving compartment tractor 12 is coupled to an elongated truck body 14 at an articulated joint 16. The truck 10 includes a sideview mirror assembly 18 (referred to at times as a mirror) rotatably mounted to a left hand side of the tractor 12. and a sideview mirror assembly 20 (referred to at times as a mirror) rotatably mounted to a right hand side of the tractor 12. One or both mirrors 18 and 20 include one or more motors to rotate the mirror horizontally (about axis B), and to rotate the mirror vertically (about axis A). Located within the cab are powered mirror controls for the left and right mirrors 18, 20 that allow the driver to move the mirror(s) 18, 20 horizontally and/or vertically.

A control unit 400 is also mounted inside the cab of tractor 10 and coupled to the motor(s) of mirror(s) 18 and 20. The control unit is mounted in a position that is readily accessible to the driver and can be configured for operating a single sideview mirror or for operating both a right hand side and left hand sideview mirrors.

Generally, the driver operates the mirror controls to position one of the mirrors (for example, the left mirror) in a home setpoint position that permits the operator to have a first view of the roadway adjacent to the vehicle. The home setpoint position is programmed into the control unit. The driver can then use the mirror controls to position the mirror in a scanning setpoint position that provides the driver with a second, different view of the roadway adjacent to the vehicle. The scanning setpoint position is also set in the control unit, as described below.

When the driver is operating the vehicle, the mirror is normally oriented in the home setpoint position and provides the driver with the first view of the roadway adjacent to the vehicle. When the driver wants to have the second view of the roadway (for example, when the driver is changing lanes), the driver actuates an activate switch on the control unit. The control unit then moves the mirror from the home setpoint position to the scanning setpoint position to provide the driver with the second view. The control unit then moves the mirror back to the home setpoint position to provide the driver with the normal view of the road.

Depending on the configuration of the control unit (for example, if the control unit is designed to control operation of both mirrors), the driver can perform the same operation with the other mirror.

For instance, and referring to FIG. 2, when the driver is operating the vehicle, the mirrors 18 and 20 are normally positioned in the home setpoint position. In the example of FIG. 2, the driver has set the home setpoint position to provide the driver with a view of the lanes adjacent to the vehicle. While the driver is traveling in lane A, as shown in FIG. 2, this is generally area B.

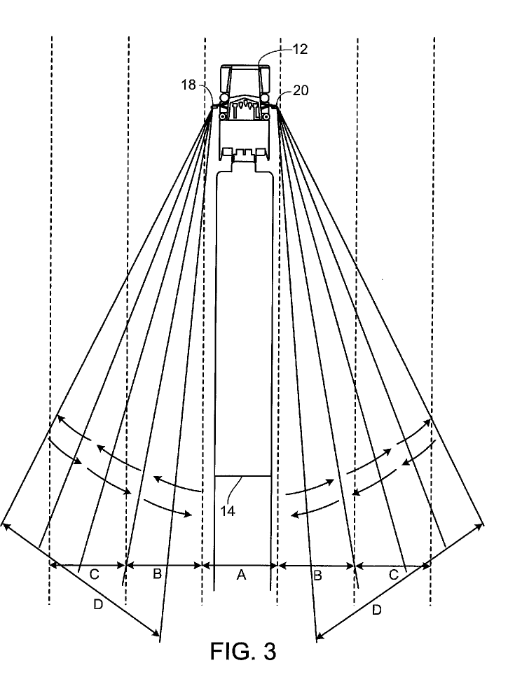

Referring to FIG. 3, when the driver wishes to change lanes, he or she actuates the activate switch on the control unit. One or both mirrors 18, 20 are then rotated to the scanning setpoint position. In the example of FIG. 3, the driver has set the scanning setpoint position to provide the driver with a view of a larger section of the area B and of the lane next to the lane adjacent to the vehicle (generally area C).

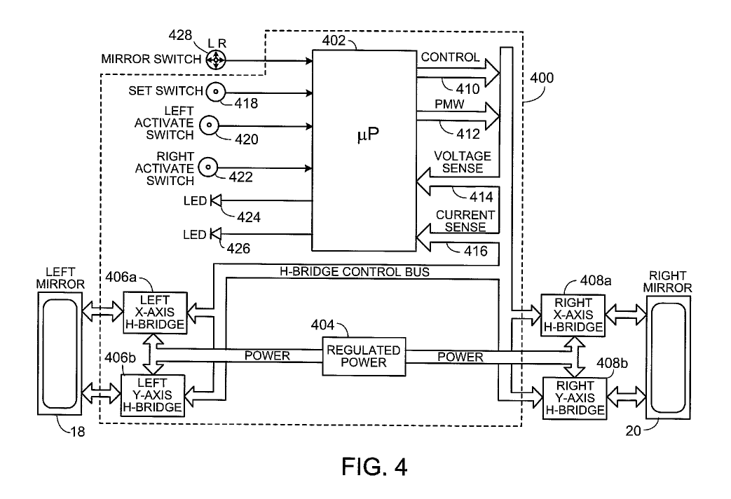

Referring to FIG. 4, one implementation of the control unit 400 includes a number of components packaged together in a single box that is installed in the passenger area of the vehicle, and connected to the existing power mirror system of the vehicle. For instance, the control unit 400 is connected to the existing powered mirrors 18 and 20 and to the existing mirror control switch 428.

The control unit 400 includes various control switches 418-426, a microprocessor 402 (for example, a PIC microntroller model 16F872 from Microchip Technology, Inc.), a regulated power supply 404 (for example, Model No. LM2586-ADJ from National Semiconductor, Inc. tuned to 15V), and four H-bridges 406a, 406b, 408a, and 408b (for example, H-bridge with model no. SN75441 ONE from Texas Instruments, Inc.).

In general, an H-Bridge causes the rotation of a motor by directing power through the motor via two different paths. One path is for rotation in a first direction, the other for rotation in the second direction. When no power is flowing through the motor, the motor does not rotate. H-bridge 406a causes the rotation of the motor controlling horizontal rotation of the left mirror 18 by directing power from the regulated power supply 404 through the motor, while H-bridge 406b causes rotation of the motor controlling vertical rotation of the left mirror 18 by directing power from the regulated power supply 404 through the motor. H-bridge 408a causes the rotation of the motor controlling horizontal rotation of the right mirror 20 by directing power from the regulated power supply 404 through the motor, while H-bridge 406b causes rotation of the motor controlling vertical rotation of the right mirror 20 by directing power from the regulated power supply 404 through the motor.

The H-bridges 406a, 406b, 408a, and 408b are connected to the microprocessor by control signals 410 and drive signals 412. The control signals 410 control the direction of power flow through a given H-bridge so as to control the direction of rotation of a given motor. The drive signals 412 turn on a given H-bridge to cause rotation of the corresponding motor.

The microprocessor 402 accomplishes speed control of a motor by using pulse width modulated (PWM) signals for the drive signals 412, which causes the H-bridges to turn on and off in a PWM fashion, thereby applying a voltage to the motor in a PWM fashion. In general, the speed of a motor is related to the voltage applied across the motor. The higher the voltage supplied, the higher the RPM. However, motors generally do not detect voltage pulses, but rather detect only the average voltage. Thus, by using PWM signals, the effective voltage applied to the motor, and hence the speed of the motor, can be varied by varying the duty cycle of the PWM signal. For example, a 15 volt source applied to the motor as a PWM signal at 80% duty cycle (on 80% of time, off 20% of time) appears to the motor as a constant 12 volts DC (15 v*80%) and the motor therefore rotates at the motor speed corresponding to 12 volts DC.

The microprocessor 402 is also connected to the H-bridges 406a, 406b, 408a, and 408b by voltage sense signals 414 and current sense signals 416 that provide feedback about the voltage across the motor's coils and the current running through the motor's coils. In various implementations, the voltage sense 414 and current sense signals 416 may be used during a calibration process. For instance, these signals may be used to determine a range of mirror movement during a calibration process when absolute mirror position control is used, as described further below.

The voltage sense signals 414 and/or the current sense signals 416 can also be used for “sensorless” feedback of the speed of and/or load on the motor so as to control the positioning of the mirror. When an electric motor is spun mechanically with no current applied, the motor becomes a generator and produces a voltage directly proportional to the rate of spin (e.g., rotations per minute or RPM). Using the PWM method, there are periods in time where no current is applied to the motor and the inertia of the motor creates the generator effect. The voltage generated, referred to as Back EMF, is measurable and provides a “sensorless” RPM feedback mechanism.

Just as voltage through an electric motor is directly proportional to RPM, current through a motor is directly proportional to torque. As with voltage, current can be measured to provide a “sensorless” mechanism to determine the load on a motor.

This information can be used, for example, in a control loop to control the speed and/or torque of the motor when moving the mirror from the home setpoint position to the scanning setpoint position. For example, the voltage sense signal 414 can be used to verify that the motor is rotating at the expected speed when moving the mirror to the scanning setpoint position, and this information can be used to adjust the PWM duty cycle to insure that the motor is moving at the correct speed.

The microprocessor 402 is connected to a set switch 418, a left activate switch 420, a right activate switch 422, a left LED 424, and a right LED 426. The set switch 418 is used to signal the microprocessor 402 to set the home and scanning setpoint positions. The left activate 420 and right activate 422 switches are used to signal the microprocessor 402 during operation to automatically move the left and right mirrors, respectively, to the scanning setpoint position. Some or all of the switches and LEDs 418-426 can be provided on the control unit box containing the microprocessor 402, or some of all of them can be coupled to the control unit box by wires and mounted in the cabin, for example, on the dash.

The microprocessor 402 is also coupled to the mirror control switch 428. The mirror control switch 428 instructs the microprocessor 402 to move the left or right mirror 18, 20 so that the driver can position the mirror. For instance, the driver can use the mirror control switch 428 to position the mirrors 18, 20 in the home setpoint positions and the scanning setpoint positions. Mirror switch 428 can be provided on the control unit box containing the microprocessor 402, or can be coupled to the control unit box by wires and mounted in the cabin, for example, on the dash. In some implementations, the mirror control switch 428 is the pre-existing mirror control switch for controlling pre-existing power mirrors on the vehicle.

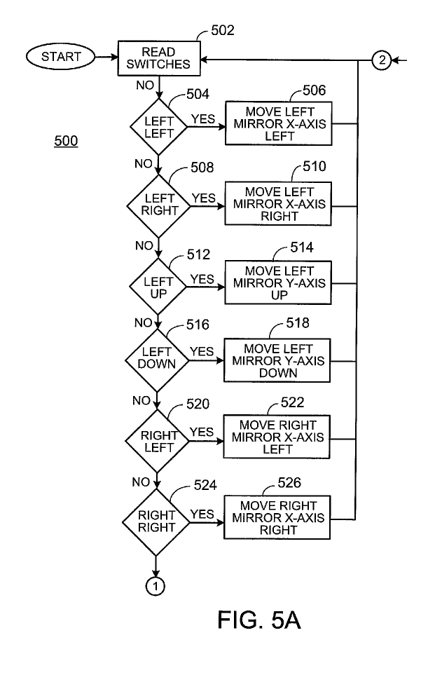

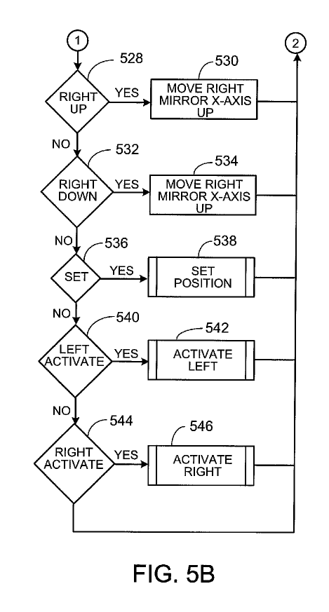

Referring to FIGS. 5A and 5B, a flow chart shows an example of a process 500 that can be performed by the microprocessor 402 to detect and react to the actuation of one of the switches 418-428. The microprocessor 402 reads the switches 418-428 to determine when one of the switches 418-428 is actuated.

When the mirror control switch 428 is actuated to move the left hand mirror 18 horizontally or vertically (504, 508, 512, and 514), the microprocessor 402 responds by sending control and drive signals 414, 416 to the H-bridges to control the appropriate motor of the left mirror 18 to rotate in the appropriate direction, thereby moving the mirror (506, 510, 514, and 518). Likewise, when the mirror switch 428 is actuated to move the right hand mirror 20 horizontally or vertically (520, 524, 528, and 532), the microprocessor 402 responds by sending control and drive signals 414, 416 to the H-bridges to control the appropriate motor of the right mirror 20 to rotate in the appropriate direction, thereby moving the mirror (522, 526, 530, and 534).

When the set switch 418 is actuated (536), the microprocessor 402 performs a set position process to set the home and scanning setpoint positions (538). When either the left or right activate switches 420, 422 are actuated (540, 544), the microprocessor 402 performs a corresponding activate scan process (546) to automatically move the mirror(s) to the scanning setpoint position.

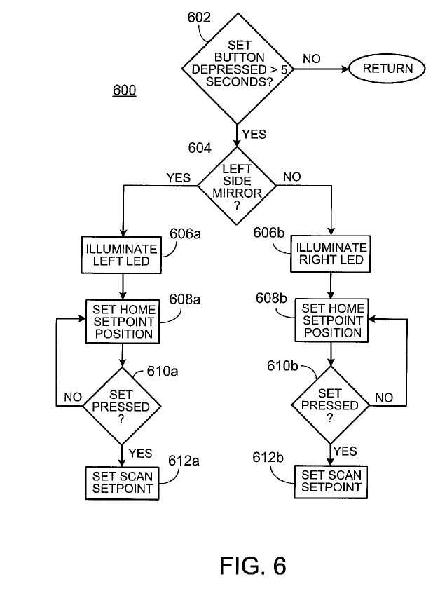

FIGS. 6-8 show various processes for implementing a set position process and an activate scan process. The processes shown in these figures are examples in which changes in position, as opposed to absolute positioning, are used when controlling the scanning movement of the mirror. In such an implementation, the home setpoint position is set as a zero position, and the horizontal distance and vertical distance from the home setpoint to the scanning setpoint are stored. When the mirror is to be moved to the scanning setpoint position, the mirror is moved the horizontal distance and vertical distance to the scanning setpoint position.

FIG. 6 shows an example of a set position process that can be performed by the microprocessor 402 to set the home and scanning setpoint position. When the user depresses the set switch 418, the microprocessor 402 detects whether the set switch 418 is depressed for more than five seconds (602). If not, then the microprocessor 402 returns to monitoring the switches 418-428 using, for example, process 500.

If the set switch 418 is depressed for greater than five seconds, the microprocessor 402 switches to a set mode to set the home and scanning setpoint positions. This mode generally entails setting the home and scanning setpoint positions for both the left mirror 18 and right mirror 20. Therefore, the microprocessor 402 first checks whether the left mirror 18 should be set (604). If not (for example, because the left mirror 18 has already been set), then the microprocessor proceeds with setting the home and scanning setpoint positions for the right mirror 20. If so, then the microprocessor proceeds with setting the home and scanning setpoint positions for the left mirror 18. The steps for setting the left and right mirrors 18, 20 are generally the same.

To set the home and scanning setpoint positions of the left and right mirrors 18, 20, the microprocessor 402 first illuminates either the left or right LED 424, 426, depending on which mirror is being set (606a and 606b). The microprocessor 602 then receives input from the mirror control switch 428 as the driver moves the mirror to the desired home setpoint position. In response to the input from the mirror control switch 428, the microprocessor 402 moves the mirror in the direction indicated by the driver as the driver moves the mirror to the desired home setpoint position (608a and 608b).

The microprocessor 402 checks whether the set switch is depressed again (610a and 610b). If not, the microprocessor 402 waits for further input from the mirror control switch 428 and, upon receiving such input, moves the mirror accordingly. If the set switch is depressed (610a and 610b), the microprocessor 402 performs a set scanning setpoint process (612a and 612b).

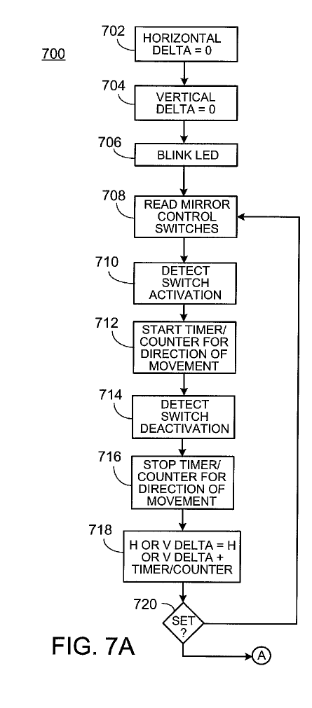

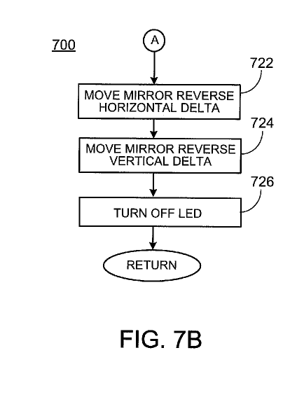

FIGS. 7A and 7B show an example of a set scanning setpoint process 700. A horizontal delta variable and a vertical delta variable are both set to zero (702 and 704). This effectively sets the home setpoint position as a zero position. The microprocessor then blinks the LED for the corresponding mirror (for example, if the left mirror is being set, the left LED is blinked).

The microprocessor 402 reads the mirror control switch 418, and when the driver operates the mirror control switch 428, the microprocessor 402 begins moving the mirror and, at the same time, tracking the movement of the mirror in the horizontal and vertical directions. In general, there are two ways in which the microprocessor can track the movement of the mirror. The first way involves counting the number of pulses that are applied to the motor to move the mirror in a particular direction. If the pulse width stays the same for setting the scanning setpoint position, and later moving the mirror into the scanning setpoint in response to the activation switch, then the microprocessor 402 can apply the same number of pulses to the motor to move the mirror to scanning setpoint position from the home setpoint position.

The second way involves keeping track of the amount of time the motor is rotated. If the duty cycle is the same for setting the scanning setpoint position, and later moving the mirror into the scanning setpoint in response to the activation switch, then the microprocessor 402 can move the motor for the same amount of time to move the mirror to the scanning setpoint position from the home position. In other words, because the motor is being run at the same speed (because the duty cycle is the same), the microprocessor simply needs to move the mirror for the same amount of time when performing scanning that the mirror was moved when setting the scanning setpoint position.

In either method, when setting the scanning setpoints, the microprocessor starts a timer or counter (712) when the mirror control switch is activated (710). The timer or counter is run for each direction (horizontal and vertical) and a given timer or counter runs forward for movement in one direction (forward) and runs backward for movement in the opposite direction (reverse). The timer or counter continues to run until the mirror control switch 428 is deactivated (714). At that point, the timer or counter is stopped (716) and the horizontal and vertical delta variables are updated (718). In particular, the horizontal and vertical delta variables are set equal to their previous values plus or minus, as appropriate, the value of the timer or counter. As a result, these variables contain the horizontal distance and vertical distance from the home setpoint position to the current setpoint position.

If the set switch 418 is not depressed at this point, the microprocessor 402 continues to read the mirror control switch 428 (708). This way the driver can further move the mirror to a different position for the desired scanning setpoint position. The further movement of the mirror is tracked, and the horizontal and vertical delta variables updated accordingly (710-718).

If the set switch 418 is depressed once the mirror is stopped, the microprocessor 402 moves the mirror the horizontal delta distance back towards the home setpoint position (722), and moves the mirror the vertical delta distance back towards the home setpoint position (724) so that the mirror is at the home setpoint position. Lastly, the microprocessor turns off the illuminated LED to inform the driver that the setpoints have been set (726). The distance from the home setpoint position to the scanned setpoint position is stored in the horizontal and vertical delta variables, and is used to move the mirror to the scanning setpoint position when the driver actuates the activate switch.

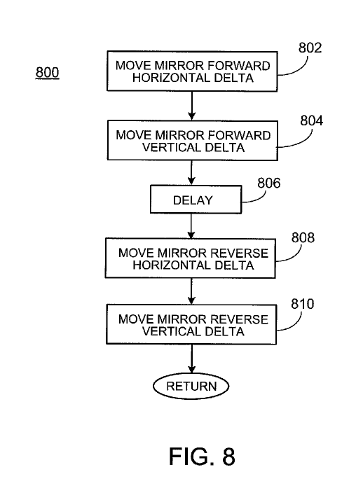

FIG. 8 shows an example of an activate scan process 800 that can be performed by the microprocessor 402 to move the mirror to the scanning setpoint position. Once the user depresses and releases the activate switch 420, 422 for a particular mirror 18, 20, the microprocessor 402 moves the mirror the horizontal delta distance towards the scanning setpoint position (802) and moves the mirror the vertical delta distance towards the scanning setpoint position (804). After doing so, the mirror is in the scanning setpoint position and the microprocessor 402 waits a predetermined delay period, for example, 5 seconds (806), which results in the mirror staying in the scanning setpoint position for the delay period. At the end of the delay period, the microprocessor 402 moves the mirror the horizontal and vertical delta distances back towards the home setpoint position (808 and 810), thereby returning the mirror to the home setpoint position.

In other implementations, the mirror can be moved to and remain in the scanning setpoint position while the driver holds the activate switch, and moved back to the home setpoint position once the driver releases the activate switch, rather than moving the mirror to the scanning setpoint position, holding for a delay period, and then automatically return the mirror to the home setpoint position. In other implementations, the mirror can be moved to the scanning setpoint position when the driver presses the activate switch, and then remain in the scanning setpoint position until the driver again presses the activate switch, at which point the mirror is moved back to the home setpoint position.

As an alternative to using changes in position, absolute positioning of the mirror(s) can be used to control the scanning movement of the mirror(s). Implementations that use absolute position can include a calibration process that determines the mirrors total movement range in the horizontal and vertical directions.

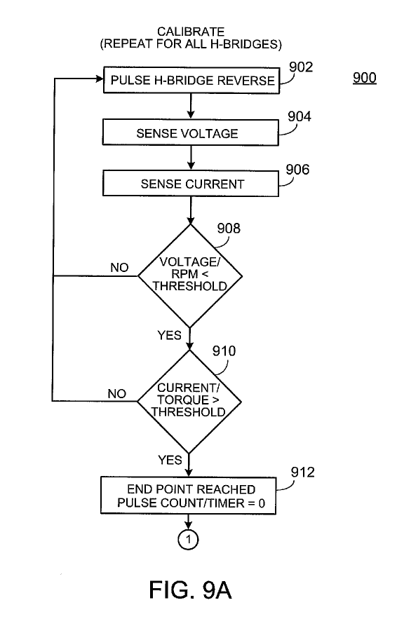

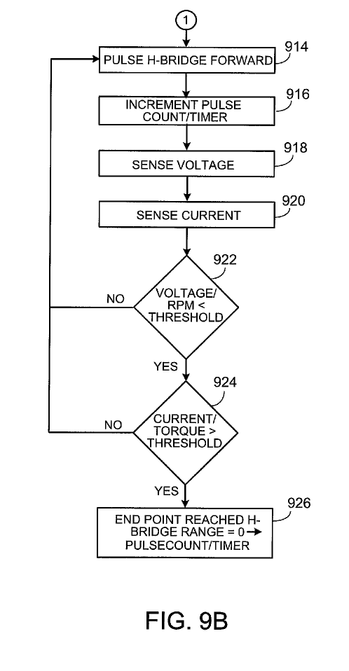

FIGS. 9A and 9B show an example of a calibration process 900 that can be employed by the microprocessor 402 to determine the total movement range of a mirror in the horizontal and vertical directions. The microprocessor 402 sends a PWM signal to the motor to move the mirror in one direction horizontally or vertically (depending on which direction is being calibrated) (902). While doing so, the microprocessor 402 reads the voltage sense signals 414 (904) and the current sense signals 416 (906). In general, when a motor stalls, the voltage across the motor will generally drop towards zero, while the current will increase above the current present when the motor is rotating. When the mirror reaches the end of its range of motion, the motor will effectively stall because it can not rotate the mirror any further. Accordingly, the end of the mirror's range of motion can be detected by detecting the combination of a voltage drop across the motor with an increase in current. Therefore, when the microprocessor 402 detects that the voltage is below a particular threshold (908) and the current through the motor is above a particular threshold (910), the microprocessor 402 sets a timer or counter to zero because this indicates the mirror has reached the end of its range of motion (912).

Once the end of the range is detected, the microprocessor 402 moves the mirror horizontally or vertically in the opposite direction (914) and increments the timer or counter while doing so (916). At the same time, the microprocessor 402 reads the voltage sense signals 414 (918) and the current sense signals 416 (920). When the microprocessor 402 detects that the voltage is below a particular threshold (922) and the current through the motor is above a particular threshold (924), indicating the opposite end of the range of motion, the microprocessor 402 sets a variable for the mirror movement range equal to the timer or counter (926).

To implement a system that controls the mirror based on absolute position, the microprocessor 402 sets a position variable equal to the value in the mirror movement range variable once calibration is complete. When the motor is then moved, the position variable is decremented or incremented based on the direction of movement. In this way, the absolute position of the mirror is stored in a horizontal position variable and a vertical position variable. To set the home setpoint position and scanning setpoint position, the microprocessor 402 implements processes similar to those described above to allow the driver to move the mirror to the home setpoint position and the scanning setpoint position, but instead of tracking the distance from the home setpoint position to the scanning setpoint position, the microprocessor 402 sets the home setpoint position equal to the values in the position variables when the mirror is in the desired home setpoint position, and similarly sets the scanning setpoint position equal to the values in the position variables when the mirror is in the desired scanning setpoint position.

A number of implementations have been described. Nevertheless, it will be understood that various modifications may be made.

What is claimed is:

1. A mirror system for facilitating the viewing of an area of a roadway rearwardly and adjacent to a vehicle, the system comprising:
at least one mirror mounted to one side of a driver compartment of the vehicle;
at least one motor coupled to the mirror and configured to move the mirror when activated;
an activate switch;
a controller coupled to the motor and the activate switch, wherein the controller is configured to:
activate the motor to move the mirror to a first position out of a range of possible positions in response to mirror movement input from a driver of the vehicle, wherein the first position provides the driver with a first view of a roadway adjacent to the vehicle;
receive an indication from the driver that the first position is a home position;
activate the motor to move the mirror to a second position out of a range of possible positions in response to mirror movement input from the driver of the vehicle, wherein the second position provides the driver with a second, different view of the roadway adjacent to the vehicle;
receive an indication from the driver that the second position is a scanning position;
store information regarding the home position of the mirror and the scanning position of the mirror; and
in response to the driver activating the activate switch, activate the motor to move the mirror from the home position to the scanning position, based on the stored information, without using a position feedback device coupled to the mirror to provide position feedback about the mirror to the controller.

2. The system of claim 1 wherein the controller is coupled to the mirror through an existing power mirror system in the vehicle.

3. The system of claim 1 wherein:
the at least one motor comprises a first motor and a second motor, the first motor being configured to rotate the mirror horizontally when activated and the second motor being configured to rotate the mirror vertically when activated; and
the controller is configured to activate both the first motor and the second motor to move the mirror both horizontally and vertically from the home position to the scanning position.

4. The system of claim 1 wherein:
the stored information regarding the home position of the mirror and the scanning position of the mirror comprises an amount of time taken to move the mirror from the home position to the scanning position;
to move the mirror from the home position to the scanning position, based on the stored information, without using a position feedback device coupled to the mirror to provide position feedback about the mirror to the controller, the controller is configured to:
activate the motor to move the mirror towards the scanning position from the home position for the stored amount of time.

5. The system of claim 1 wherein:
the controller is configured to apply a pulse width modulated signal to the motor to move the mirror;
the stored information regarding the home position of the mirror and the scanning position of the mirror comprises a number of pulses of the pulse width modulated signal applied to the motor to move the mirror from the home position to the scanning position;
to move the mirror from the home position to the scanning position, based on the stored information, without using a position feedback device coupled to the mirror to provide position feedback about the mirror to the controller, the controller is configured to:
apply the stored number of pulses to the motor to move the mirror from the home position to the scanning position.

6. The system of claim 1 wherein:
the stored information regarding the home position of the mirror and the scanning position of the mirror comprises an absolute position of the home position within the range of positions and an absolute position of the scanning position within the range of positions;
to move the mirror from the home position to the scanning position, based on the stored information, without using a position feedback device coupled to the mirror to provide position feedback about the mirror to the controller, the controller is configured to:
activate the motor to move the mirror from the absolute position of the home position to the absolute position of the scanning position.

7. The system of claim 1 wherein the controller is configured to:
sense a voltage across the motor or a current running through the motor; and
control a speed or torque of the motor while the motor is activated to move the mirror from the home position to the scanning position.

8. The system of claim 1 wherein the controller is configured to activate the motor to move the mirror from the scanning position to the home position, based on the stored information, without using a position feedback device coupled to the mirror to provide position feedback about the mirror to the controller.

9. The system of claim 8 wherein the controller is configured to activate the motor to move the mirror from the scanning position to the home position in response to the driver releasing the activate switch.

10. The system of claim 8 wherein the controller is configured to hold the mirror at the scanning position for a predetermined delay period before activate the motor to move the mirror from the scanning position to the home position.

11. A method of operating a mirror system to facilitate the viewing of an area of a roadway rearwardly and adjacent to a vehicle, the mirror system including at least one mirror mounted to one side of a driver compartment of the vehicle and at least one motor coupled to the mirror and configured to move the mirror when activated, the method comprising:
activating the motor to move the mirror to a first position out of a range of possible positions in response to mirror movement input from a driver of the vehicle, wherein the first position provides the driver with a first view of a roadway adjacent to the vehicle;
receiving an indication from the driver that the first position is a home position;
activating the motor to move the mirror to a second position out of a range of possible positions in response to mirror movement input from the driver of the vehicle, wherein the second position provides the driver with a second, different view of the roadway adjacent to the vehicle;
receiving an indication from the driver that the second position is a scanning position;
storing information regarding the home position of the mirror and the scanning position of the mirror; and
in response to the driver activating an activate switch, activating the motor to move the mirror from the home position to the scanning position, based on the stored information, without using a position feedback device coupled to the mirror to provide position feedback about the mirror.

12. The method of claim 11 further comprising:
receiving the mirror control input through an existing mirror controller of an existing power mirror system in the vehicle.

13. The method of claim 11 wherein
the at least one motor comprises a first motor and a second motor, the first motor being configured to rotate the mirror horizontally when activated and the second motor being configured to rotate the mirror vertically when activated; and
activating the motor to move the mirror from the home position to the scanning position includes activating both the first motor and the second motor to move the mirror both horizontally and vertically from the home position to the scanning position.

14. The method of claim 11 wherein:
the stored information regarding the home position of the mirror and the scanning position of the mirror comprises an amount of time taken to move the mirror from the home position to the scanning position;
activating the motor to move the mirror from the home position to the scanning position includes activating the motor to move the mirror towards the scanning position from the home position for the stored amount of time.

15. The method of claim 11 wherein:
a pulse width modulated signal is applied to the motor to move the mirror;
the stored information regarding the home position of the mirror and the scanning position of the mirror comprises a number of pulses of the pulse width modulated signal applied to the motor to move the mirror from the home position to the scanning position;
activating the motor to move the mirror from the home position to the scanning position includes applying the stored number of pulses to the motor to move the mirror from the home position to the scanning position.

16. The method of claim 11 wherein:
the stored information regarding the home position of the mirror and the scanning position of the mirror comprises an absolute position of the home position within the range of positions and an absolute position of the scanning position within the range of positions;
activating the motor to move the mirror from the home position to the scanning position includes activating the motor to move the mirror from the absolute position of the home position to the absolute position of the scanning position.

17. The method of claim 11 further comprising:
sensing a voltage across the motor or a current running through the motor; and
controlling a speed or torque of the motor while the motor is activated to move the mirror from the home position to the scanning position.

18. The method of claim 11 further comprising activating the motor to move the mirror from the scanning position to the home position, based on the stored information, without using a position feedback device coupled to the mirror to provide position feedback about the mirror.

19. The method of claim 18 wherein activating the motor to move the mirror from the scanning position to the home position includes activating the motor in response to the driver releasing the activate switch.

20. The system of claim 18 further comprising holding the mirror at the scanning position for a predetermined delay period before activating the motor to move the mirror from the scanning position to the home position.

21. A control unit for use with an existing power mirror system in a vehicle to facilitate the viewing of an area of a roadway rearwardly and adjacent to a vehicle, the control unit comprising:
a housing storing:
at least one motor control circuit configured to be coupled to at least one existing power mirror of the power mirror system, the at least one existing power mirror mounted to one side of a driver compartment of the vehicle and including at least one motor configured to move the mirror when activated;
a regulated power supply coupled to the at least one motor control circuit and configured to provide power used by the motor control circuit to activate the motor of the at least one existing power mirror;
an activate switch; and
a microprocessor coupled to the at least one motor control circuit and the activate switch, the microprocessor being configured to be coupled to at least one existing mirror control switch of the existing power mirror system, wherein the microprocessor is programmed with instructions that, when executed, cause the microprocessor to perform the following operations:
cause the motor control circuit to activate the motor to move the mirror to a first position out of a range of possible positions in response to a driver of the vehicle using the mirror control switch to provide mirror movement input, wherein the first position provides the driver with a first view of a roadway adjacent to the vehicle;
receive an indication from the driver that the first position is a home position;
cause the motor control circuit to activate the motor to move the mirror to a second position out of a range of possible positions in response to a driver of the vehicle using the mirror control switch to provide mirror movement input, wherein the second position provides the driver with a second, different view of the roadway adjacent to the vehicle;
receive an indication from the driver that the second position is a scanning position;
store information regarding the home position of the mirror and the scanning position of the mirror; and
in response to the driver activating the activate switch, cause the motor control circuit to activate the motor to move the mirror from the home position to the scanning position, based on the stored information, without using a position feedback device coupled to the mirror to provide position feedback about the mirror to the microprocessor.

22. The control unit of claim 21 wherein:
the at least one motor comprises a first motor and a second motor, the first motor being configured to rotate the mirror horizontally when activated and the second motor being configured to rotate the mirror vertically when activated; and
the microprocessor is programmed to cause the motor control circuit to activate both the first motor and the second motor to move the mirror both horizontally and vertically from the home position to the scanning position.

23. The control unit of claim 21 wherein:
the stored information regarding the home position of the mirror and the scanning position of the mirror comprises an amount of time taken to move the mirror from the home position to the scanning position;
to move the mirror from the home position to the scanning position, based on the stored information, without using a position feedback device coupled to the mirror to provide position feedback about the mirror to the microprocessor, the microprocessor is programmed with instructions that cause the microprocessor to:
cause the motor control circuit to activate the motor to move the mirror towards the scanning position from the home position for the stored amount of time.

24. The control unit of claim 21 wherein:
the microprocessor is configured to cause the motor control circuit to apply a pulse width modulated signal to the motor to move the mirror;
the stored information regarding the home position of the mirror and the scanning position of the mirror comprises a number of pulses of the pulse width modulated signal applied to the motor to move the mirror from the home position to the scanning position;
to move the mirror from the home position to the scanning position, based on the stored information, without using a position feedback device coupled to the mirror to provide position feedback about the mirror to the microprocessor, the microprocessor is programmed with instructions that cause the microprocessor to:
cause the motor control circuit to apply the stored number of pulses to the motor to move the mirror from the home position to the scanning position.

25. The control unit of claim 21 wherein:
the stored information regarding the home position of the mirror and the scanning position of the mirror comprises an absolute position of the home position within the range of positions and an absolute position of the scanning position within the range of positions;
to move the mirror from the home position to the scanning position, based on the stored information, without using a position feedback device coupled to the mirror to provide position feedback about the mirror to the microprocessor, the microprocessor is programmed with instructions that cause the microprocessor to:
cause the motor control circuit to activate the motor to move the mirror from the absolute position of the home position to the absolute position of the scanning position.

26. The control unit of claim 21 wherein the microprocessor is programmed with instructions that cause the microprocessor to:
sense a voltage across the motor or a current running through the motor; and
control a speed or torque of the motor while the motor is activated to move the mirror from the home position to the scanning position.

27. The control unit of claim 19 wherein the microprocessor is programmed with instructions that cause the microprocessor to cause the motor control circuit to activate the motor to move the mirror from the scanning position to the home position, based on the stored information, without using a position feedback device coupled to the mirror to provide position feedback about the mirror to the microprocessor.

28. The control unit of claim 27 wherein the microprocessor is programmed with instructions that cause the microprocessor to cause the motor control circuit to activate the motor to move the mirror from the scanning position to the home position in response to the driver releasing the activate switch.

29. The control unit of claim 27 wherein the microprocessor is programmed with instructions that cause the microprocessor to hold the mirror at the scanning position for a predetermined delay period before causing the motor control circuit to activate the motor to move the mirror from the scanning position to the home position.
